(19) United States
(12) Patent Application Publication
(10) Pub. No.: US 2004/0134191 A1
(43) Pub. Date: Jul. 15, 2004

(54) Control device

(76) Inventor: Michael Kuhn, Wotenitz (DE)

Correspondence Address: Mark S Bicks, Roylance Abrams Berdo & Goodman, Suite 600, 1300 19th Street NW, Washington, DC, 20036, US

(21) Appl. No.: 10/476,071

(22) PCT Filed: Jun. 27, 2002
(86) PCT No.: PCT/EP02/07090

(30) Foreign Application Priority Data
Oct. 4, 2001 (DE) 101 48 962.5

(51) Int. Cl. F16D 31/02

(52) U.S. Cl. 60/413

(57) ABSTRACT

The invention relates to a control device, in particular for working machines, such as wheel loaders, excavators or similar comprising at least one working tool (12) that can be actuated by means of at least one hydraulic working cylinder (10), in particular a loading shovel. Said device comprises a control block for controlling the hydraulic fluid paths between the working cylinder (10), a hydraulic fluid supply (P) and a tank (T). Said device also comprises at least one hydraulic accumulator (22) and a shut-off valve (32), which has a controllable valve member (34) and is located between the working cylinder (10) and the accumulator (22). Said valve member is connected in the transmission position for connecting the accumulator (22) in order to damp the motion of the working cylinder (10). A selector valve (26) that can be controlled by the control block (20) is connected in the fill line (24), blocking said line (24) in the non-actuated state and the shut-off valve (32) is connected in a secondary line (30) that is connected to the fill line (24), said shut-off valve being impinged in the open direction by accumulator pressure and being decompressed in the closed direction. This permits increased safety to be achieved for working machines and prevents an excess load from being placed on the damping accumulator.

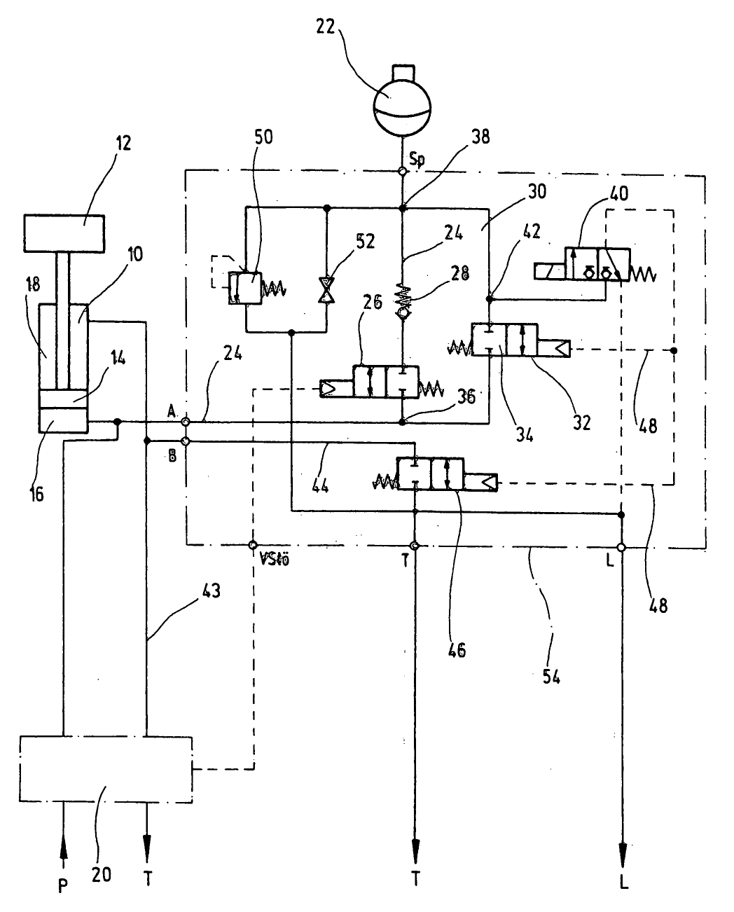

The invention relates to a control device, in particular for machines such as wheeled loaders, excavators, or the like having at least one operating implement, a tractor loader in particular, actuatable by at least one hydraulic operating cylinder, with a control block for control of the pressure medium paths between operating cylinders, a pressure medium supply, and a tank, with at least one hydraulic accumulator and a stop valve mounted between the operating cylinder and a stop valve mounted between the operating cylinder and the accumulator, the stop valve having an actuatable valve element which is switched to its conducting position by means of the operating cylinder in order to connect the accumulator for the purpose of cushioning a load.

In a generic control device as disclosed in DE 41 29 509 C2 the hydraulic accumulator may be connected to the pressure medium source by way of a feed line, the stop valve operating between the operating cylinder and the accumulator being mounted directly in the feed line itself and the valve element of the stop valve having accumulator pressure applied to it in the direction of closing and having pressure removed from it in the direction of opening.

In the case of the disclosed solution the respective hydraulic accumulator is charged during raising of the load by means of the respective operating cylinder.

If the accumulator pressure rises to a value corresponding to the load pressure, a special seat valve intended for the purpose closes, the control compartment space of this seat valve being charged with pressure. For the purpose of connecting the respective hydraulic suspension accumulator to the respective operating cylinder a three-way valve is automatically reversed; this process can take place automatically, the accumulator pressure then equaling the load pressure on the piston side of the respective operating cylinder, since the hydraulic damping accumulator has been charged to this pressure by way of the feed line. The damping accordingly takes place at the pressure predominating in the piston space of the respective operating cylinder, not at a higher or lower pressure, which would additionally result in undesirable movement of the piston of the operating cylinder. Sagging of the load on connection of the respective hydraulic damping accumulator in particular is prevented. If, however, dynamic loads are applied to the hydraulic operating cylinder, ones in the form of peak loads, for example, which may occur when the operating machine in the form of a wheeled loader runs into material to be loaded, such as broken stones, soil, or the like, these peak loads damaging the damping accumulator are transmitted directly to the latter.

It is true that, in order to prevent this occurrence, DE 39 09 205 C1 has already proposed, for a conventional hydraulic system for construction machines such as wheeled loaders, tractors, or the like, that there be branched off inside a main line leading to the hydraulic operating cylinders a connecting line which is provided with a stop valve which is then bridged by the feed line, which in turn has a pressure reduction valve. The disclosed configuration in question does then make it possible to charge the respective hydraulic accumulator during raising of the load by means of the respective hydraulic cylinder, specifically with a higher pressure determined by the pressure reduction valve. However, when the damping accumulator is connected by way of the stop valve to the piston side of the respective operating cylinder, the pressure on the piston side does not necessarily correspond to the higher damping pressure on the accumulator side, so that extension movement may unintentionally be transmitted to the operating cylinders and accordingly to the loading shovel.

On the basis of this state of the art the object of the invention is further to improve disclosed solutions by developing a control device which provides increased security in the area of machines such as wheeled loaders, excavators, or the like, and which aids in preventing overloading of accumulators resulting from peak loads, in particular in the operation of loading a machine. The object as thus formulated is attained by a control device having the characteristics specified in claim 1 in its entirety.

In that, as specified in the characterizing part of claim 1, a switching valve controlled by a control block is connected to the feed line, this switching valve blocking the feed line when not operated, and in that the stop valve, to which accumulator pressure is applied in the direction of opening, is connected to a secondary branch line connected to the feed line, which stop valve is relieved of pressure in the direction of flow, the respective hydraulic accumulator may be charged by way of the feed line by means of the respective operating cylinder during raising of the load, so that the accumulator pressure then corresponds to the hoisting pressure under load. If the feed line is then blocked by way of the stop valve controlled by the control block and the stop valve connected to the secondary branch line also remains in the blocking position, the damping accumulator is separated from the operating cylinder and pressure peaks which occur, for example, during work with the operating implement, such as a boom, loading shovel, or the like, do not exert a damaging effect on the hydraulic accumulator. The stop valve is then switched to its transmission position to activate the suspension, the stop valve being simultaneously blocked in the feed line, and, since the load to be cushioned is adapted to the earlier raising and feed pressure of the accumulator, upward extension of the operating cylinder may occur. Consequently, with the control device claimed for the invention not only is the respective hydraulic damping accumulator protected from harmful peak loads, but security during operation of the machine is also increased.

Other advantageous embodiments are specified in the dependent claims.

The control device claimed for the invention is described in detail with reference to an embodiment as illustrated in the drawing.

The sole FIGURE illustrates the essential primary components of the control device claimed for the invention, in the form of a circuit diagram not drawn to scale.

The control device claimed for the invention is provided in particular for use in machines such as wheeled loaders, excavators, and the like. To actuate and drive a loading or excavating shovel use is made of at least one hydraulic operating cylinder 10, which is provided for raising and lowering a predetermined load 12 with a piston rod unit 14. The specific piston of this unit 14 subdivides the operating cylinder 10 into a piston space 16 and a rod space 18. Several operating cylinders (not shown) connected in parallel with each other may be provided, as a function of the configuration of the machine.

A conventional control block 20 usually provided for these tasks is used to drive the operating cylinder 10. The control block 20 in question serves to control the pressure medium paths between the operating cylinder 10, a pressure medium supply P, and a tank T. The control device also has a hydraulic accumulator 22 which serves as damping accumulator, it being possible in this instance as well to employ a plurality of accumulators as a function of the definition of the problem. The accumulator 22 is one of conventional design also referred to as a “hydraulic accumulator.” A feed line 24 connected to the control block 20 with its pressure supply P extends between operating cylinder 10 and accumulator 22. A first switching valve 26 and a return valve 28 which is spring-loaded and opens in the direction of the accumulator 22 are also connected to the feed line 24.

In the circuit diagram shown the first switching valve 26 is in its position blocking the feed line 24. A secondary branch line 30 provided with a stop valve 32 is also connected to the feed line 24. The stop valve 32 has a controllable valve element 34 which serves to connect the accumulator 22 for the purpose of damping the movement (cushioning) of the operating cylinder 10 and which may be switched to its transmission position for this purpose. However, as is indicated by the circuit diagram shown, the stop valve, when in its initial position, assumes its position blocking the secondary branch line 30.

Consequently, the switching valve 26 and the stop valve 32 are connected in parallel with each other to the feed line 24 or the secondary branch line 30, that is, the two free ends of the secondary branch line 30 discharge, in the respective direction of the fluid upstream and downstream from the switching valve 26, into the feed line 24, at the connection points 36, 38.

As is also to be seen in the circuit diagram, another switching valve 40, which is shown in the unactuated state and which when actuated moves the valve element 34 of the stop valve 32 to its opening position, is connected to the secondary branch line 30 between the accumulator 22 and the stop valve 32. When not actuated, the other switching valve 40 is connected to an oil leakage line L. The switching valve 40 in question may be controlled and operated in particular by the operator of the machine. If the switching valve 40 has been switched to its operating position, the accumulator pressure is conducted to the stop valve 32 by way of the part of the secondary branch line 30 which is connected to the accumulator 22 and moves this stop valve 32 to is transmission position. The other switching valve 40 is connected for this purpose to secondary branch line 30 by way of the connection point 42, between connection point 38 and the stop valve 32.

The rod space 18 of the operating cylinder 10 is connected by way of a connecting line 43 to the control block 20 and by way of another connecting line 44 to a third switching valve 46. In addition, the third switching valve 46 is connected to the tank T and, as the circuit diagram indicates, may also be actuated by way of a control line 48 and accordingly by way of the second switching valve 40. As a result of operation of the third switching valve 46, this valve is moved by way of the control line 48 from its blocked position to its transmission position and the pressure in the rod space 18 in the direction of the tank T may be removed. In addition, a pressure control valve 50 otherwise connected to the accumulator 22 at the connection point 38 is connected to an oil leakage line L. In addition, a manually actuatable stop device 52 is provided which extends in parallel with the pressure control valve.

The valve configuration referred to may be concentrated in one valve block 54; the operating cylinder 10 with connections A, B may be connected to this valve block 54. The accumulator 22 may be connected to the valve block 54 by way of the connection Sp and a control line of the control block 20 communicates with the valve block 54 by way of the connection VStö for actuation of the first switching valve 26. Connections T and L are also provided for connection of the tank or oil leakage line. The first switching valve 26 and the third switching valve 46 and the stop valve 32 are in the form of 2/2-way valves and in their normal position are all connected for blocking. The second switching valve 40 consists of a 3/2-way valve which, when not operated, establishes a fluid conducting connection between the control line 48 and the oil leakage line L. Both the stop valve 32 and the third switching valve 56 must control large volume flows, the volume flow passing through the third switching valve 46 being smaller than that passing through the stop valve 32. This results from the circumstance that the third switching valve 46 is associated with the rod space 18 and the stop valve 32 with the piston space 16, change in the volume of which spaces results in different volume flows. In any event, when the operating cylinder 10 is introduced only a very small pressure difference, which may be lower than 1 bar, is available in the third switching valve 46.

For the sake of better understanding of the operation of the control device claimed for the invention, this device is explained in detail in what follows on the basis of a description of operation. Provision is made such that the suspension itself remains blocked for filling the loading shovel and its emptying if a boom is to be raised or lowered. For the purpose of moving the load 12 by way of the hydraulic operating cylinder 10 the control block 20 is actuated and the control fluid or flow of the switching valve (VStö) opens the first switching valve 26, so that fluid conduction is thus established by way of the opening return valve 28. When the load 12 is raised, the accumulator 22 is charged by the return valve 28 in question with the maximum pressure occurring during the respective operating cycle, so that the raising pressure for the load 12 corresponds to the filling pressure of the accumulator 22.

The suspension may now be activated for traveling with the machine, the control block 20 being switched to its neutral (closed) position. The second switching valve 40 is now actuated, the accumulator pressure being applied to the two switching-operated valves 32 and 46 by way of the control line 48 and the valves opening. The third switching valve 46 is actuated and connects the piston space 18 to the tank T, while the stop valve 32 is additionally switched and connects the piston space 16 of the operating cylinder 10 to the accumulator 22, with the result that the suspension described is activated.

For the purpose of deactivating the suspension described the second switching valve 40 is then actuated, so that the pilot control lines 48 of the valves 32 and 46 are connected to the tank line. The valves 32 and 46 referred to consequently close, the accumulator 22 remaining charged and the suspension being blocked. With the suspension blocked the loading shovel may now be inserted into the loading material, such as that in the form of broken stones, the high pressures which may occur in the hoisting cylinders not being transmitted to the accumulator 22 and not causing damage, since the first switching valve 26, in the form of a sliding valve, remains closed at this time and thus interrupts the fluid conducting connection by way of the feed line 24. Since the suspension strictly speaking is useful only in driving operation, in effect it is activated only for driving operation and the control device claimed for the invention ensures that the suspension is blocked if the accumulator 22 could be overloaded by pressure peaks when load is introduced or if the operating implement (loading shovel) actuated by means of the operating cylinder 10 comes to be in an operating condition, with or without load, in which an unintentional movement process (raising of a boom or the like) possibly resulting from connection of the accumulator 22 could become dangerous.

1. A control device, in particular for machines such as wheeled loaders, excavators, or the like, having an operating implement (12) actuatable by way of at least one hydraulic operating cylinder (10), a loading shovel in particular, having a control block (20) for control of the pressure medium paths between the operating cylinder (10), a pressure medium supply (P), and a tank (T), having at least one hydraulic accumulator (22), and having, mounted between the operating cylinder (10) and the accumulator (22), a stop valve (32) having an actuatable valve element (34) which is switched to its transmission position for connection of the accumulator (22) for the purpose of damping the movement of the operating cylinder (10), characterized in that a switching valve (26) actuatable by the control block (20) is connected to the feed line (24), which switching valve (26) blocks the feed line (24) when not actuated, and in that the stop valve (32), to which accumulator pressure is applied in the direction of opening and from which pressure is removed in the direction of closing, is connected to a secondary branch line (30) connected to the feed line (24).

2. The control device as claimed in claim 1, wherein the switching valve (26) and the stop valve (32) are connected in parallel with each other to the feed line (24) and secondary branch line (30) and wherein the secondary branch line (30) ends in the feed line (24) with its two free ends upstream and downstream from the switching valve (26) in the respective direction of fluid flow.

3. The control device as claimed in claim 1 or 2, wherein a return valve (28) opening in the direction of the accumulator (22) is mounted in the feed line (24) between switching valve (26) and accumulator (22).

4. The control device as claimed in one of claims 1 to 3, wherein another switching valve (40) is connected to the secondary branch line (30) between the accumulator (22) and the stop valve (32), which switching valve (40) when actuated moves the valve element (34) of the stop valve (32) to its opening position.

5. The control device as claimed in one of claims 1 to 4, wherein the piston space (16) and the rod space (18) of the operating cylinder (10) are connected to the control block (20) for the purpose of conducting fluid and the piston space (16) communicates with the feed line (24) for the purpose of conducting fluid.

6. The control device as claimed in claim 5, wherein the rod space (18) may be connected to the tank (T) by means of a third switching valve (46) which is connected to the rod space (18) of the operating cylinder (10) for the purpose of conducting fluid.

7. The control device as claimed in claim 6, wherein the third switching valve (46), like the stop valve (32), may be simultaneously switched to its transmission position under the control of the second switching valve (40).

8. The control device as claimed in one of claims 1 to 7, wherein the feed line (24) connected to the accumulator (10) is protected by way of a pressure control valve (50) which is connected to a tank line (T).
